(19) United States
(12) Patent Application Publication
(10) Pub. No.: US 2021/0065030 A1
(43) Pub. Date: Mar. 4, 2021

(54) ARTIFICIAL INTELLIGENCE BASED EXTRAPOLATION MODEL FOR OUTAGES IN LIVE STREAM DATA

(71) Applicant: International Business Machines Corporation, Armonk, NY (US)

(72) Inventors: Ankur Tagra, Bangalore (IN); Shajeer K. Mohammed, Bangalore (IN); Abhinav Gupta, Benguluru (IN); Geetika` Sahu, Bengaluru (IN)

(21) Appl. No.: 16/550,909

(22) Filed: Aug. 26, 2019

(51) Int. Cl. G06N 5/04; G06F 11/14; G06K 9/62; G06F 17/17

(52) U.S. Cl. CPC G06N 5/046; G06F 17/17; G06K 9/6256; G06F 11/1402

(57) ABSTRACT

Aspects of the present invention disclose a method for regeneration of live stream data lost during an outage. The method includes one or more processors identifying a data feed of a live stream. The method further includes applying a cognitive model to the data feed of the live stream. The method further includes modifying parameters of the cognitive model based at least in part on a modified weight, wherein the cognitive model performs one or more calculations to generate the modified weight based at least in part on a set of training data of the data feed. The method further includes identifying an outage in the data feed of the live stream. The method further includes generating data corresponding to the outage in the data feed of the live stream, wherein the generated data is based at least in part on the modified weight of the set of training data.

### BACKGROUND

The present invention relates generally to the field of training processes, and more particularly to utilizing machine learning in the regeneration of live stream data lost during an outage.

In recent years, the growth of the manufacture of devices embedded with computing capacity have created a variety of prospects for edge computing applications. Edge computing is a distributed computing paradigm that brings computer data storage closer to the source where distributed systems technology interacts with the physical world. Although, edge computing refers to decentralized data processing at the edge of a network, which does not need contact with a centralized cloud. However, edge computing is capable of interaction with a centralized cloud.

Distributed computing is a field of computer science that studies distributed systems, whose components may be located on different networked computers. The components interact with one another in order to achieve a common goal by communicating and coordinating their actions by passing messages. Distributed computing provides various approaches to solve computational problems.

An edge device is a device which provides an entry point into an enterprise or a service provider core network. In general, edge devices may be routers that provide authenticated access to faster, more efficient core networks. Examples of edge devices include routers, routing switches, integrated access devices, multiplexers, and a variety of wide area network (WAN) access devices.

### SUMMARY

Aspects of the present invention disclose a method, computer program product, and system for regeneration of live stream data lost during an outage. The method includes one or more processors identifying a data feed of a live stream. The method further includes one or more processors applying a cognitive model to the data feed of the live stream. The method further includes one or more processors modifying parameters of the cognitive model based at least in part on a modified weight, wherein the cognitive model performs one or more calculations to generate the modified weight based at least in part on a set of training data of the data feed. The method further includes one or more processors identifying an outage in the data feed of the live stream. The method further includes one or more processors generating data corresponding to the outage in the data feed of the live stream, wherein the generated data is based at least in part on the modified weight of the set of training data.

### BRIEF DESCRIPTION OF THE DRAWINGS

FIG. 1 is a functional block diagram of a data processing environment, in accordance with an embodiment of the present invention.

FIG. 2 is a flowchart depicting operational steps of a program, within the data processing environment of FIG. 1, for regeneration of live stream data lost during an outage, in accordance with embodiments of the present invention.

FIG. 3 is an example depiction of a line graph that correlates to live stream data, in accordance with embodiments of the present invention.

FIG. 4 is a block diagram of components of the client device and server of FIG. 1, in accordance with an embodiment of the present invention.

### DETAILED DESCRIPTION

Embodiments of the present invention allow for regeneration of live stream data lost during an outage. Embodiments of the present invention monitor data of a live stream and continuously modify weight of data utilized to train model. Additional embodiments of the present invention identify data outages in a live stream and optimize the storage of modified weights of data utilized to train model.

Some embodiments of the present invention recognize that there are various reason issues in a network that can cause an outage in the data flow of a live stream. Consequently, an outage in data collection disrupts the sequence and completeness of data. Thus, this incompleteness of data attributes effect overall insight that drawn from the data. Additionally, utilizing incomplete data to train a machine learning model depreciates the accuracy of the machine learning model. Existing approaches of ignoring the outage data, using available data, and using average values or other linear equation methods lead to inaccuracy of results due to attributes of outage data not being considered during training of the machine learning model. Various embodiments of the present invention resolve this issue modifying the weight of corresponding data to train a machine learning model and generate the outage data.

Embodiments of the present invention reduces network resources utilization by utilizing a compressor algorithm and/or dynamic buffer pool allocated for optimal use of network resources. Thus, reducing volume of data that data must be transmitted (i.e., the consequent traffic). Additionally, embodiments of the present invention reduce network power resources by decreasing the volume of traffic and distance over which the traffic must be transmitted. Embodiments of the present invention improve the accuracy of a machine learning model by creating more sequential and complete training data to derive insight from.

Implementation of embodiments of the invention may take a variety of forms, and exemplary implementation details are discussed subsequently with reference to the Figures.

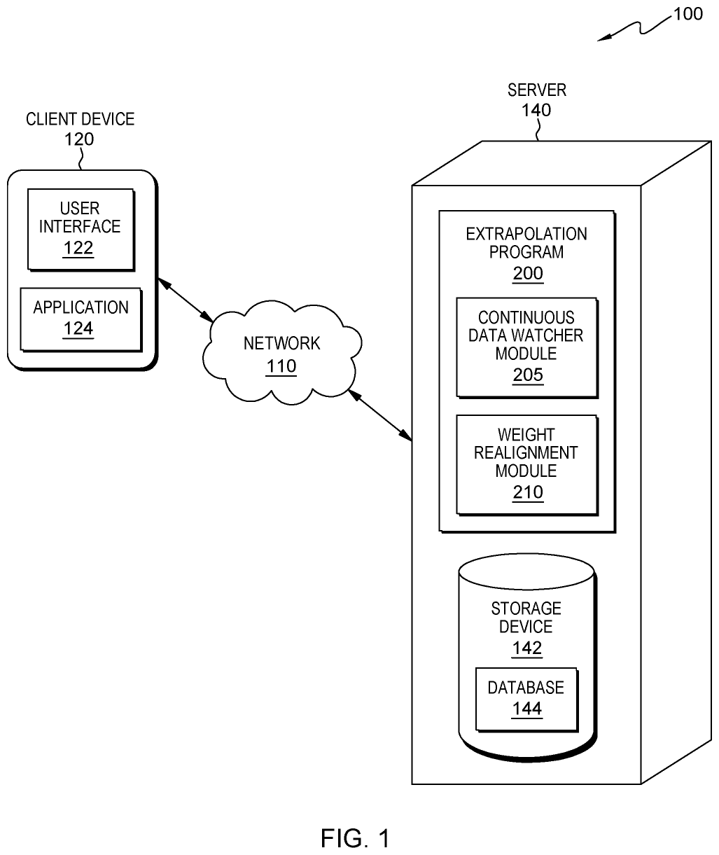

The present invention will now be described in detail with reference to the Figures. FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Various embodiments of the present invention can utilize accessible sources of personal data, which may include personal devices (e.g., client device 120) social media content, and/or publicly available information. For example, embodiments of the present invention can optionally include a privacy component that enables the user to opt-in or opt-out of exposing personal information. The privacy component can enable the authorized and secure handling of user information, such as tracking information, as well as personal information that may have been obtained, is maintained, and/or is accessible. The user can be provided with notice of the collection of portions of the personal information and the opportunity to opt-in or opt-out of the collection process. Consent can take several forms. Opt-in consent can impose on the user to take an affirmative action before the data is collected. Alternatively, opt-out consent can impose on the user to take an affirmative action to prevent the collection of data before that data is collected.

An embodiment of data processing environment 100 includes client device 120, and server 140, all interconnected over network 110. In one embodiment, client device 120 and server 140 communicate through network 110. Network 110 can be, for example, a local area network (LAN), a telecommunications network, a wide area network (WAN), such as the Internet, or any combination of the three, and include wired, wireless, or fiber optic connections. In general, network 110 can be any combination of connections and protocols, which will support communications between client device 120 and server 140, in accordance with embodiments of the present invention. In an example, a client device 120 sends a request to server 140 via the Internet (e.g., network 110 ) over which server 140 returns a response.

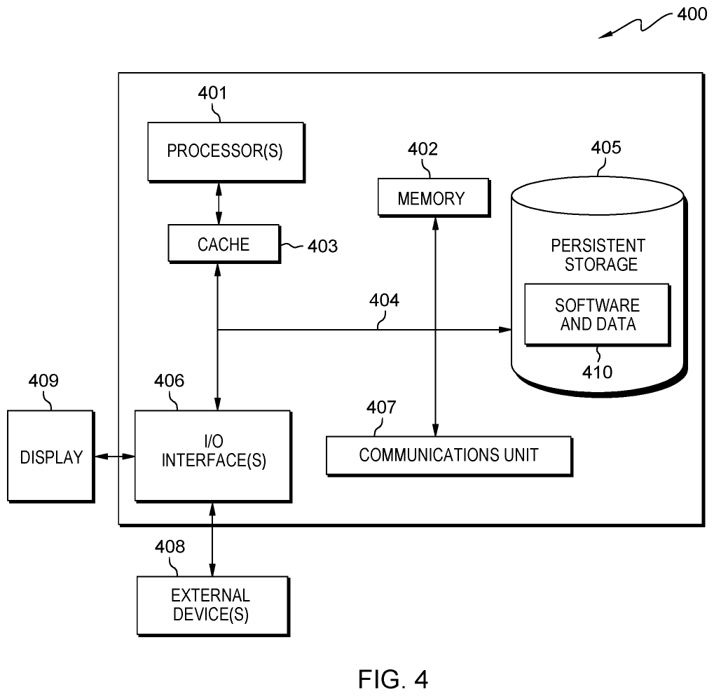

In various embodiments of the present invention, client device 120 may be a workstation, personal computer, digital video recorder (DVR), media player, personal digital assistant, mobile phone, or any other device capable of executing computer readable program instructions, in accordance with embodiments of the present invention. In general, client device 120 is representative of any electronic device or combination of electronic devices capable of executing computer readable program instructions. In one embodiment, client device 120 is of a client in a distributed application structure (e.g., client-server model). For example, multiple instances of client device 120 may exist within a client-server model. In this example, one instance of client device 120 is a source of a live stream broadcast, while another instance of client device 120 requests the live stream from server 140. Client device 120 may include components as depicted and described in further detail with respect to FIG. 4, in accordance with embodiments of the present invention.

Client device 120 includes user interface 122 and application 124. User interface 122 is a program that provides an interface between a user of client device 120 and a plurality of applications that reside on the client device. A user interface, such as user interface 122, refers to the information (such as graphic, text, and sound) that a program presents to a user, and the control sequences the user employs to control the program. A variety of types of user interfaces exist. In one embodiment, user interface 122 is a graphical user interface. A graphical user interface (GUI) is a type of user interface that allows users to interact with electronic devices, such as a computer keyboard and mouse, through graphical icons and visual indicators, such as secondary notation, as opposed to text-based interfaces, typed command labels, or text navigation. In computing, GUIs were introduced in reaction to the perceived steep learning curve of command-line interfaces which require commands to be typed on the keyboard. The actions in GUIs are often performed through direct manipulation of the graphical elements. In another embodiment, user interface 122 is a script or application programming interface (API). Application 124 is a computer program designed to run on client device 120. An application frequently serves to provide a user with similar services accessed on personal computers (e.g., web browser, playing music, or other media, etc.).

In various embodiments of the present invention, server 140 may be a desktop computer, a computer server, or any other computer systems, known in the art. In certain embodiments, server 140 represents computer systems utilizing clustered computers and components (e.g., database server computers, application server computers, etc.), which act as a single pool of seamless resources when accessed by elements of data processing environment 100. In general, server 140 is representative of any electronic device or combination of electronic devices capable of executing computer readable program instructions. Server 140 may include components as depicted and described in further detail with respect to FIG. 4, in accordance with embodiments of the present invention.

Server 140 includes storage device 142, database 144, extrapolation program 200, continuous data watcher module 205, and weight realignment module 210. Storage device 142 can be implemented with any type of storage device, for example, persistent storage 405, which is capable of storing data that may be accessed and utilized by server 140 and client device 120, such as a database server, a hard disk drive, or a flash memory. In one embodiment storage device 142 can represent multiple storage devices within server 140. In various embodiments of the present invention storage device 142 stores a plurality of information, such as data of continuous data watcher module 205 and weight realignment module 210 in database 144. Database 144 may represent one or more organized collections of data stored and accessed from server 140. In one embodiment, database 144 stores data utilized to train an estimation model. For example, database 144 may include time-dependent data and/or weight matrices used to generate data corresponding to an interruption of live stream data. In another embodiment, data processing environment 100 can include additional servers (not shown) that host additional information that accessible via network 110.

In various embodiments of the present invention, extrapolation program 200 monitors communications between client device 120 and server 140 and identifies outages of live stream data. In one embodiment, extrapolation program 200 identifies outages in data of a live stream. For example, extrapolation program 200 utilizes continuous data watcher module 205 to identify temporal periods that include an interruption of the continuous stream of data of a live stream. In this example, a live stream is multimedia that a client constantly receives while being delivered by a provider. In another embodiment, extrapolation program 200 generates outage data of a live stream. For example, extrapolation program 200 utilizes weight realignment module 210 to modify a weight of data used to generate data corresponding to an interruption in the live stream. In another embodiment, extrapolation program 200 may be accessed locally on client device 120.

Extrapolation program 200 can identify and generate missing data of a live stream in real or near real-time. In one embodiment, extrapolation program 200 utilizes continuous data watcher 132 to identify an outage in a live stream. In another embodiment, extrapolation program 200 utilizes weight realignment module 210 to modify weights to train an estimation model and generate data corresponding to an outage of data of a live stream. In yet another embodiment, extrapolation program 200 transmits generated data to client device 120. For example, extrapolation program 200 fills data interruptions of a requested live stream with generated data.

Continuous data watcher module 205 is a subprogram of extrapolation program 200 that monitors communications between a client and a server to identify outages in live stream data. In one embodiment, continuous data watcher module 205 monitors data of a live stream to identify interruptions in the data of the live steam. For example, continuous data watcher module 205 continuously monitors communications between a client and server. In this example, continuous data watcher module 205 detects an interruption in data of the live stream. In another embodiment, continuous data watcher module 205 initiates generation of data to corresponding to an interruption in the live stream. For example, continuous data watcher module 205 detects an interruption in data of a live stream and communicates a signal indicating the interruption, which initializes weight realignment module 134. In various embodiments of the present invention, continuous data watcher module 205 may execute locally on network 110, client device 120, or server 140.

Weight realignment module 210 is a subprogram of extrapolation program 200 that generates data of a live stream that corresponds to a disruption or outage of the data flow in the live stream. In one embodiment, weight realignment module 210 modifies a weight of data utilized to train a data estimation model. For example, weight realignment module 210 continuously updates weight matrices of data used to train a data estimation model based on prior corresponding data (e.g., data of a corresponding defined time period of a previous day). In another embodiment, weight realignment module 210 regenerates data corresponding to an interruption detected by continuous data watcher module 205 utilizing data of data base 144. For example, weight realignment module 210 modifies the weight of the training data of an estimation model and uses data of a database to generate data corresponding to a detected interruption of live stream data. In various embodiment of the present invention, weight realignment module 2010 may execute locally on client device 120, server 140, or network 110.

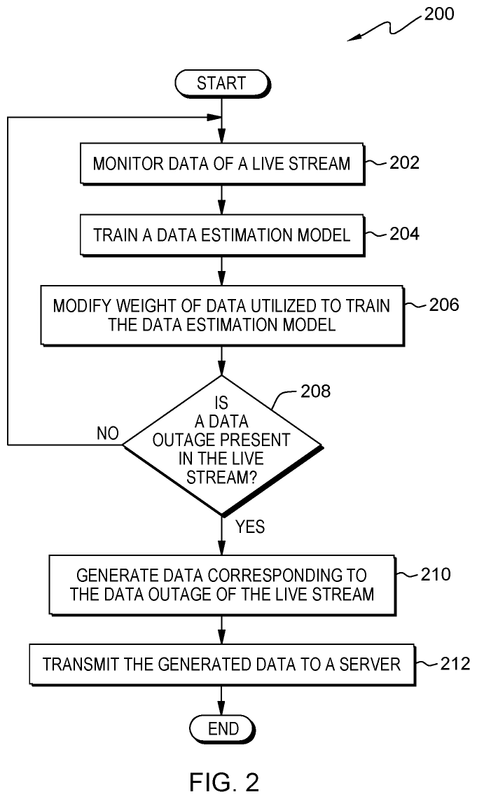

FIG. 2 is a flowchart depicting operational steps of extrapolation program 200, a program for regeneration of live stream data lost during an outage, in accordance with embodiments of the present invention. In one embodiment, extrapolation program 200 initiates in response to detecting a communication between client device 120 and server 140. For example, extrapolation program 200 initiates in response to detecting a request of a client (e.g., client device 120 ) for resources of a server (e.g., server 140 ).

In step 202, extrapolation program 200 monitors data of a live stream. In various embodiments of the present invention, extrapolation program 200 runs a plurality of intermittent network tests to determine baseline performance parameters and statistics of a network interface such as average error rates, latency rates, transmission overhead, upload rate, download rate, and general network/internet connectivity. In one embodiment, extrapolation program 200 detects, identifies, and determines the technical and performance parameters, details, statistics of one or more network interfaces and associated networks available to a computing device (e.g., client device 120, server 140, etc.). In another embodiment, extrapolation program 200 utilizes error rate tests to measure, determine, and store the number of transferred bits that have been altered due to noise, interferences, distortion, or bit synchronization errors in database 144.

In various embodiments, extrapolation program 200 acts as an inline proxy and/or a transparent proxy ‘sitting’ in between a computing device and subsequent computing device, node, destination network, and/or server. In this embodiment, all network traffic to and from the computing device will transmit (e.g., travel) through extrapolation program 200. In another embodiment, extrapolation program 200 utilizes continuous data watcher module 205 to monitor communication activity of client device 120 to determine a data and/or network transmission and/or request. Additionally, responsive to extrapolation program 200 detecting an attempted data transmission, extrapolation program 200 continues to monitor the data transmission. For example, extrapolation program 200 detects a request of a client (e.g., client device 120 ) for resources (e.g., a URL of a live stream) from a database of a server (e.g., server 140 ), and continues to monitor communications for transmission of a response to the request.

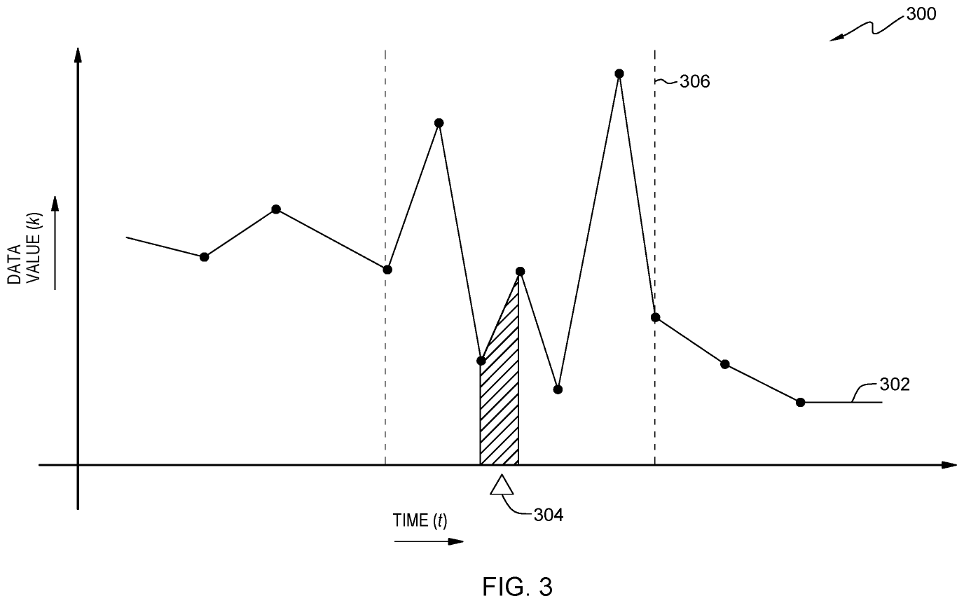

In step 204, extrapolation program 200 trains a data estimation model. In various embodiments of the present invention, features of a training data set (i.e., a set of examples used to fit the parameters of the model) utilized to train a data estimation model are stationary, time dependent, and recursive in nature. For example, due to the continuous and cyclic nature of weather patterns, data used to train a data estimation model may reflect temperature over a period of time at particular geolocation. Thus, the features of a training set of data (e.g., temperatures) are stationary, time dependent, and recursive in nature. In one embodiment, extrapolation program 200 utilizes weight realignment module 210 to calculate a weight of training data and utilize the calculated weight to generate data corresponding to an identified outage the estimation model predicts. In another embodiment, extrapolation program 200 utilizes continuous data watcher module 205 to collect data of communications between client device 120 and server 140 and stores the collected data in database 144. For example, continuous data watcher module 205 is an edge device that collects data of a live stream, which continuous data watcher 205 stores in a server database (e.g., database 144). For example, the collected data may include values of data as depicted in FIG. 3.

FIG. 3 is an example depiction of a live stream data graph 300, which is a graph of a data set of a live stream at a prior time frame, that extrapolation program 200 utilizes to identify outages, train a data estimation model, and generate data corresponding to an identified outage. Live stream data graph 300 includes data value 302, time interval 304 (e.g., time of day), and data interruption 306. For example, data value 302 is representative of one or more values of a continuous data stream of a previous day that is used to train an estimation model. In another example, time interval 304 is a defined period used to identify data values missing during data interruption 306. In yet another example, data interruption 306 representative of one or more time intervals of an outage where one or more values of data value 302 are not available. In an example embodiment, extrapolation program 200 generates data within data interruption 306.

In another embodiment, extrapolation program 200 utilizes data of database 144 to create a training set of data. For example, extrapolation program 200 vectorizes data (e.g., network latency, bitrates, network errors, throughput, time interval, etc.) creating training and testing sets that include a number of features that are descriptive of missing values of a live stream during an interruption of data flow of the live stream. Additionally, extrapolation program 200 utilizes the processed training sets to perform supervised training of a data estimation model. As would be recognized by one skilled in the art, supervised training determines the difference between a prediction and a target (i.e., the error), and back-propagates the difference through the layers such that the data estimation model “learns.”

In example embodiments, extrapolation program 200 can utilize an equation for a data estimation model that includes:

Estimatedvalue=Σᵢ₌₁ⁿwi*vi (1)

where ‘vᵢ’ is the data value at an instance which is ‘i’ intervals from a current value, ‘n’ is configurable as a machine parameter, and ‘wi’ is calculated below in step 206 during a safe phase (e.g., time intervals before and after an interruption in data flow).

In step 206, extrapolation program 200 modifies weight of data utilized to train the data estimation model. In one embodiment, extrapolation program 200 utilizes collected data of database 144 and weight realignment module 210 to calculate a weight of the collected data and stores the calculated weight in storage device 142. In another embodiment, extrapolation program 200 utilizes weight realignment module 210 to continuously update a weight of the data estimation model utilizing data continuous data watcher module 205 collects. For example, extrapolation program 200 initializes all weights to one (1). In example embodiments, extrapolation program 200 can utilize equations for weight initialization, including:

wi=1, ∀i ∈n (2)

W=[wi]∀i ∈ n (3)

where ‘W’ is a weight matrix, ‘wi’ is the weight of data which is ‘i’ interval before the current data value, ∀i is a mathematical symbol for all values of ‘i’, and ‘n’ is a set of all intervals (i.e., ‘i’ ranges from 1 to ‘n’).

Additionally, extrapolation program 200 performs a normalized expansion of weight matrix ‘W’. In example embodiments, extrapolation program 200 can utilize an equation for normalized expansion that includes:

$$W = \frac{[ w 1 , w 2 , … wn ] * 1}{min ( W )} \qquad ( 4 )$$

where ‘[w1, w2, . . . . wn]’ is a set of all the weight of data which is ‘i’ interval before the current data value and ‘min(W)’ is a minimum value of the weight matrix.

In this example, extrapolation program 200 realigns weights based on variance in computation between target values and source values. In example embodiments, extrapolation program 200 can utilize an equation for realignment of a weight that includes:

$$Wnew = w i + ( o 2 - o 1 ) * ( I i 2 - I i 1 ) * ( 1 + {log ( \vert \frac{o 2}{o 1} - \frac{Ii 2}{Ii 1} \vert )}^{( \frac{o 2}{o 1} - \frac{I i 2}{I i 1} )} \qquad ( 5 )$$

where ‘Wnew’ is an updated weight matrix, ‘o2, o1’ are target values, and ‘Ii2, Ii1’ are the changes in values in ‘i^{th}’ interval prior to the current value. In one scenario, if ‘o2, o1’ varies substantially as compared to ‘Ii2, Ii1’, then ‘Wnew’ is updated to a high weight.

In another embodiment, extrapolation program 200 stores updated weight matrices in storage device 142. For example, extrapolation program 200 utilizes a compressor algorithm (e.g., data differencing) to store one or more weight matrices on a server. In another example, extrapolation program 200 utilizes a dynamic buffer pool (e.g., storage device 142) allocated for optimal use of memory resources to store one or more weight matrices.

In decision step 208, extrapolation program 200 determines whether a data outage is present in the live stream. In various embodiments of the present invention, extrapolation program 200 utilizes data that continuous data watcher module 205 collects a live stream of data, which is stored in database 144, and determines whether an interruption in continuous data is present in communications of client device 120 and server 140. In one embodiment, extrapolation program 200 utilizes the aforementioned tests to identify and predict data transmission failures (e.g., interruptions). For example, extrapolation program 200 may determine the network connectivity of a computing device and network resources essential to complete a data transmission. Extrapolation program 200 can then determine and/or categorize said data transmission as a failure (e.g., failed data transmission) or complete.

In another embodiment, extrapolation program 200 utilizes an edge device to collect data to determine whether interruption of data flow of a live stream is present. In an example embodiment, extrapolation program 200 utilizes continuous data watcher module 205 to ping client device 120 and determines whether a data transmission has failed if the ping does not receive a reply, the data loss is over a predetermined loss threshold (e.g., >k/t).

In one embodiment, if extrapolation program 200 determines that no interruption of data of a live stream is present (decision step 208, “NO” branch), then extrapolation program 200 utilizes continuous data watcher module 205 to monitor data of the live stream (i.e., continues to update the weight matrix based on collected data) (in step 202). For example, extrapolation program 200 utilizes continuous data watcher module 205 to ping client device 120 and determines that no interruption in a live stream is present if a ping receives a reply. In this example, extrapolation program 200 determines that the data loss is under a predetermined loss threshold (e.g., <k/t).

In another embodiment, if extrapolation program 200 determines that an interruption of data of a live stream is present (decision step 208, “YES” branch), then extrapolation program 200 deploys weight realignment module 210 to generated data corresponding to data of the interruption of data of the live stream (in step 210). For example, extrapolation program 200 determines that an outage is present in data of a live stream and utilizes continuous data watcher module 205 to trigger (i.e., continuous data watcher module 205 sends an outage signal) extrapolation program 200 to deploy weight realignment module 210 to generate the data of the live stream corresponding to the outage.

In step 210, extrapolation program 200 generates data corresponding to the data outage of the live stream. In one embodiment, extrapolation program 200 imports a weight of storage device 142 to weight realignment module 210 to generate data corresponding to a data outage of the live stream. For example, extrapolation program 200 imports an updated weight from a dynamic buffer pool (e.g., storage device 142) to a data estimation model. In this example, extrapolation program 200 inputs source values (e.g., time intervals corresponding to an outage) into the data estimation model. Additionally, extrapolation program 200 uses the updated weight and previously collected data of a live stream to estimate (i.e., regenerate) data values of the live stream lost during the outage.

In an example embodiment, regarding FIG. 3, extrapolation program 200 generates data value 302 for data interruption 306. In this example, data value 302 may represent a set of temperature readings for an area for one or more time periods (e.g., time interval 304) of a previous day. Additionally, extrapolation program 200 identifies one or more time periods of the previous day that correspond to data interruption 306 and uses the one or more time periods as source inputs into the data estimation model. Furthermore, extrapolation program 200 updates the data estimation model with the updated weight and estimates a temperature reading corresponding to each of the one or more time periods corresponding to data interruption 306.

In step 212, extrapolation program 200 transmits the generated data to a server. In one embodiment, extrapolation program 200 retrieves generated data from weight realignment module 210 and stores the generated data in database 144. For example, extrapolation program 200 retrieves generated data of the data estimation model and stores the generated data in a database. In this example, the database includes all resources of a live stream of data provided to a client. In an example, embodiment, extrapolation program 200 stores data value 302 for time interval 304 in database 144. In this example, time interval 304 may represent one or more time periods that encompass a defined time period that corresponds to data interruption 306.

FIG. 4 depicts a block diagram of components of client device 120 and server 140, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

FIG. 3 is an example depiction of a line graph that correlates to live stream data, in accordance with embodiments of the present invention. In the depicted embodiment, FIG. 3 includes live stream data graph 300, which is a graph of a data set of a live stream at a prior time frame, that extrapolation program 200 (described previously with regard to FIG. 2) utilizes to identify outages, train a data estimation model, and generate data corresponding to an identified outage. Live stream data graph 300 includes data value 302, time interval 304 (e.g., time of day), and data interruption 306.

FIG. 4 includes processor(s) 401, cache 403, memory 402, persistent storage 405, communications unit 407, input/output (I/O) interface(s) 406, and communications fabric 404. Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random access memory (RAM). In general, memory 402 can include any suitable volatile or non-volatile computer readable storage media. Cache 403 is a fast memory that enhances the performance of processor(s) 401 by holding recently accessed data, and data near recently accessed data, from memory 402.

Program instructions and data (e.g., software and data 410) used to practice embodiments of the present invention may be stored in persistent storage 405 and in memory 402 for execution by one or more of the respective processor(s) 401 via cache 403. In an embodiment, persistent storage 405 includes a magnetic hard disk drive. Alternatively, or in addition to a magnetic hard disk drive, persistent storage 405 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405. Software and data 410 can be stored in persistent storage 405 for access and/or execution by one or more of the respective processor(s) 401 via cache 403. With respect to client device 120, software and data 410 includes data of application 124. With respect to server 140, software and data 410 includes extrapolation program 200, continuous data watcher module 205, weight realignment module 210, and data of storage device 142.

Communications unit 407, in these examples, provides for communications with other data processing systems or devices. In these examples, communications unit 407 includes one or more network interface cards. Communications unit 407 may provide communications through the use of either or both physical and wireless communications links. Program instructions and data (e.g., software and data 410) used to practice embodiments of the present invention may be downloaded to persistent storage 405 through communications unit 407.

I/O interface(s) 406 allows for input and output of data with other devices that may be connected to each computer system. For example, I/O interface(s) 406 may provide a connection to external device(s) 408, such as a keyboard, a keypad, a touch screen, and/or some other suitable input device. External device(s) 408 can also include portable computer readable storage media, such as, for example, thumb drives, portable optical or magnetic disks, and memory cards. Program instructions and data (e.g., software and data 410) used to practice embodiments of the present invention can be stored on such portable computer readable storage media and can be loaded onto persistent storage 405 via I/O interface(s) 406. I/O interface(s) 406 also connect to display 409.

Display 409 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
identifying, by one or more processors, a data feed of a live stream;
applying, by one or more processors, a cognitive model to the data feed of the live stream, wherein the cognitive model is a function that maps source inputs to target outputs;
modifying, by one or more processors, parameters of the cognitive model based at least in part on a modified weight, wherein the cognitive model performs one or more calculations to generate the modified weight based at least in part on a set of training data of the data feed;
identifying, by one more or processors, an outage in the data feed of the live stream; and
generating, by one or more processors, data corresponding to the outage in the data feed of the live stream, wherein the generated data is based at least in part on the modified weight of the set of training data.

2. The method of claim 1, further comprising:
exporting, by one or more processors, the generated data corresponding to the outage in the data feed of the live stream to a server.

3. The method of claim 2, further comprising:
inputting, by one or more processors, the generated data into the data feed of the live stream.

4. The method of claim 1, wherein modifying parameters of the cognitive model based at least in part on the modified weight, further comprises:
creating, by one or more processors, one or more training sets based on the data feed of the live stream;
creating, by one or more processors, one or more testing sets based on the data feed of the live stream; and
training, by one or more processors, the cognitive model utilizing one or more supervised training methods, wherein the supervised training methods utilize the one or more created training sets and the one or more testing sets.

5. The method of claim 4, wherein creating one or more training sets based on the data feed of the live stream, further comprises:
creating, by one or more processors, one or more training sets based on the data feed of the live stream at scheduled defined time periods.

6. The method of claim 1, further comprising:
storing, by one or more processors, the modified weight utilizing data differencing data compression;
in response to identifying an outage in the data feed of the live stream, extracting, by one or more processors, the stored modified weight; and
inputting, by one or more processors, the stored modified weight into the cognitive model.

7. The method of claim 1, wherein identifying the outage in the data feed of the live stream, further comprises:
comparing, by one or more processors, a current data value of the data feed of the live stream to a data value of a corresponding time period of a data set that correlates to the data feed of the live stream;
determining, by one or more processors, the current data value is less than the data value of the corresponding time period; and
initiating, by one or more processors, the cognitive model to generate the data corresponding to the outage in the data feed of the live stream.

8. A computer program product comprising:
one or more computer readable storage media and program instructions stored on the one or more computer readable storage media, the program instructions comprising:
program instructions identify a data feed of a live stream;
program instructions to apply a cognitive model to the data feed of the live stream, wherein the cognitive model is a function that maps source inputs to target outputs;
program instructions to modify parameters of the cognitive model based at least in part on a modified weight, wherein the cognitive model performs one or more calculations to generate the modified weight based at least in part on a set of training data of the data feed;
program instructions to identify an outage in the data feed of the live stream; and;
program instructions to generate data corresponding to the outage in the data feed of the live stream, wherein the generated data is based at least in part on the modified weight of the set of training data.

9. The computer program product of claim 8, further comprising program instructions, stored on the one or more computer readable storage media, to:
export the generated data corresponding to the outage in the data feed of the live stream to a server.

10. The computer program product of claim 8, further comprising program instructions, stored on the one or more computer readable storage media, to:
input the generated data into the data feed of the live stream.

11. The computer program product of claim 8, wherein program instructions to modify parameters of the cognitive model based at least in part on the modified weight, further comprise program instructions to:
create one or more training sets based on the data feed of the live stream;
create one or more testing sets based on the data feed of the live stream; and
train the cognitive model utilizing one or more supervised training methods, wherein the supervised training methods utilize the one or more created training sets and the one or more testing sets.

12. The computer program product of claim 11, wherein program instructions to create one or more training sets based on the data feed of the live stream, further comprise program instructions to:
create one or more training sets based on the data feed of the live stream at scheduled defined time periods.

13. The computer program product of claim 8, further comprising program instructions, stored on the one or more computer readable storage media, to:
store the modified weight utilizing data differencing data compression;
in response to identifying an outage in the data feed of the live stream, extract the stored modified weight; and
input the stored modified weight into the cognitive model.

14. The computer program product of claim 8, wherein program instructions identify the outage in the data feed of the live stream, further comprise program instructions to:
compare a current data value of the data feed of the live stream to a data value of a corresponding time period of a data set that correlates to the data feed of the live stream;
determine the current data value is less than the data value of the corresponding time period; and
initiate the cognitive model to generate the data corresponding to the outage in the data feed of the live stream.

15. A computer system comprising:
one or more computer processors;
one or more computer readable storage media; and
program instructions stored on the computer readable storage media for execution by at least one of the one or more processors, the program instructions comprising:
program instructions identify a data feed of a live stream;
program instructions to apply a cognitive model to the data feed of the live stream, wherein the cognitive model is a function that maps source inputs to target outputs;
program instructions to modify parameters of the cognitive model based at least in part on a modified weight, wherein the cognitive model performs one or more calculations to generate the modified weight based at least in part on a set of training data of the data feed;
program instructions to identify an outage in the data feed of the live stream; and;
program instructions to generate data corresponding to the outage in the data feed of the live stream, wherein the generated data is based at least in part on the modified weight of the set of training data.

16. The computer system of claim 15, further comprising program instructions, stored on the one or more computer readable storage media for execution by at least one of the one or more processors, to:
export the generated data corresponding to the outage in the data feed of the live stream to a server.

17. The computer system of claim 15, further comprising program instructions, stored on the one or more computer readable storage media for execution by at least one of the one or more processors, to:
input the generated data into the data feed of the live stream.

18. The computer system of claim 15, wherein program instructions to modify parameters of the cognitive model based at least in part on the modified weight, further comprise program instructions to:
create one or more training sets based on the data feed of the live stream;
create one or more testing sets based on the data feed of the live stream; and
train the cognitive model utilizing one or more supervised training methods, wherein the supervised training methods utilize the one or more created training sets and the one or more testing sets.

19. The computer system of claim 18, wherein program instructions create one or more training sets based on the data feed of the live stream, further comprise program instructions to:
create one or more training sets based on the data feed of the live stream at scheduled defined time periods.

20. The computer system of claim 15, further comprising program instructions, stored on the one or more computer readable storage media for execution by at least one of the one or more processors, to:
store the modified weight utilizing data differencing data compression;
in response to identifying an outage in the data feed of the live stream, extract the stored modified weight; and
input the stored modified weight into the cognitive model.
